(19) United States
(12) Patent Application Publication
(10) Pub. No.: US 2002/0062221 A1
(43) Pub. Date: May 23, 2002

(54) Distribution and notification system and method for filter replacement cartridges

(76) Inventor: Roy E. Seibert, McKinney, TX (US)

Correspondence Address: MICHAEL D. BEDNAREK, SHAW PITTMAN LLP, 1650 TYSONS BOULEVARD, MCLEAN, VA, 22102, US

(21) Appl. No.: 09/987,643

(22) Filed: Nov. 15, 2001

Related U.S. Application Data
(60) Provisional application No. 60/252,096, filed on Nov. 21, 2000.

(51) Int. Cl. G06F 17/60

(52) U.S. Cl. 705/1; 705/7; 705/8

(57) ABSTRACT

The present invention relates to a system and method for notifying customers. The system is designed to receive information from the customer related to a filter or a filtration system and equipment served by the filtration system, use that information to compute a replacement time for the filter; and contact the customer in one or more different ways at an appropriate time. Some of these forms of contact include sending reminder messages and automatically sending replacement parts or dispatching a service entity to change the filters at an appropriate time.

### RELATED APPLICATIONS

This application claims the benefit of U.S. Provisional Application No. 60/262,096, filed Nov. 21, 2000.

### BACKGROUND

1. Field of the Invention

The present invention relates generally to a distribution system, and more particularly, to a distribution and/or reminder system.

2. Background of the Invention

Many businesses and homes have installed filtration equipment to improve the purity of the process stream. Nearly all filtration equipment requires routine maintenance to function properly. An important part of this routine maintenance is the replacement of filters. Failure to regularly replace filters reduces the effectiveness of the filtration equipment and can cause failure of the equipment.

Owners and operators of filtration equipment often forget to replace their filters. There are several reasons this replacement is often overlooked. First, the requisite intervals for replacing filters can be quite long. In some cases, filters need to be replaced every month or every quarter (or 90 days), but in other cases, the interval can be several months or even several years. Owners and operators generally have difficulty tracking and remembering such long intervals.

Another problem is that it is often difficult to tell when a filter requires replacement. The difference in filtrate quality produced from a filter system with a clean versus an expended filter is significant in terms of filtrate purity. However, this difference in filtrate quality is not always apparent to a normal or non-expert user and specialized equipment or tests are required to determine chemical filtrate purity and thus determine the need to replace the filter.

Historically, owners and operators of filtration systems manually recorded the replacement dates for their filters. In some cases, the replacement dates were written on the filter itself. However, this approach has several drawbacks. Records were not always accurately kept, the records could be difficult to locate, and if the replacement dates were written on the filter itself, those replacement dates were often ignored because the filters would usually be placed in areas that were not in plain view.

Another problem associated with organizations, such as, small businesses attempting to record and remember the appropriate time to replace their filters is staff turn-over. Businesses such as restaurants are typical users of water filtration systems.

These businesses also employ a transient staff of employees and these businesses often experience high turn-over among their staff. It will often be the case that the original staff member responsible for replacing the filter the first time will have moved onto another job when the time comes to replace the filter. Due to the high turn over and the relatively long periods between filter replacements, institutional knowledge regarding the appropriate filter replacement interval is frequently lost.

Inflexibility is another problem associated with conventional, manual filter replacement processes. Filters may need to be replaced at irregular intervals. For example, consider again a restaurant. The summer months dramatically increase the restaurant's need to generate ice and, in turn, dramatically increase demands on the water filtration system. Typically, filters are used up faster during the summer months as opposed to the winter months and the appropriate time interval during summer months can be much shorter than the appropriate time interval for filter replacement in the winter months.

For most operators of filtration equipment, it is difficult enough for them to remember to replace their filters at regular intervals. It is even that much more difficult for these operators to replace their filters at different intervals throughout the year.

Additionally, it is not uncommon for business operators or homeowners to not have the information regarding the correct filter replacement cartridge, where to obtain it, how to change it and when. When new management comes into the business it is not uncommon for them to completely overlook filter change requirements until it is an emergency situation.

In some cases, pressure gauges are utilized to determine pressure drop across the filter cartridges as an indicator of filter life. This is insufficient due to the fact that many aspects of the filtration process are not always related to a pressure-drop. For example, the efficiency of filters designed for chlorine, taste and odor removal can not be determined by measuring pressure drop.

### SUMMARY OF THE INVENTION

The present invention is directed to a system and method for notifying customers including the steps of: receiving, from the customer, information related to a filter system, using that information to compute a replacement time for the filter; and contacting the customer at the replacement time.

In one aspect, the system can receive information related to a filter via a website. Customers would access a website, optionally register with the website, and provide information related to their filter equipment.

In another aspect, the system contacts the customer to remind the customer to change their filters. Customers can be contacted in a variety of ways including electronic mail, traditional mail, telephone calls, and in some cases, where customers have requested the service, the system simply ships a replacement filter at a time proximate the appropriate replacement time, or, as requested, could dispatch a service entity to physically perform the filter change.

In another aspect, the invention maintains crucial information regarding the filter replacement cartridge, the brand and model number of the system, the equipment serviced by the filter system, the location of the filter system in the business, date of installation, last filter change date and performance data.

Additional features and advantages of the invention will be set forth in the description which follows, and in part will be apparent from the description, or may be learned by practice of the invention. The objectives and advantages of the invention will be realized and attained by the structure and steps particularly pointed out in the written description, the claims and the drawings.

### BRIEF DESCRIPTION OF THE DRAWINGS

FIG. 1 is a schematic diagram of a preferred embodiment of a system in accordance with the present invention.

FIG. 2 is a flow diagram of a preferred embodiment of the present invention.

FIG. 3A is a schematic diagram of a preferred embodiment of a registration screen in accordance with the present invention.

FIG. 3B is a schematic diagram of a preferred embodiment of a registration screen in accordance with the present invention.

FIG. 4 is a schematic diagram of a preferred embodiment of a processor in accordance with the present invention.

FIG. 5 is a flow diagram of a preferred embodiment of a customer contact method in accordance with the present invention.

FIG. 6 is a flow diagram of a preferred embodiment of a customer contact method in accordance with the present invention.

FIG. 7 is a flow diagram of a preferred embodiment of a customer contact method in accordance with the present invention.

FIG. 8 is a flow diagram of a preferred embodiment of a customer contact method in accordance with the present invention.

### DETAILED DESCRIPTION OF THE INVENTION

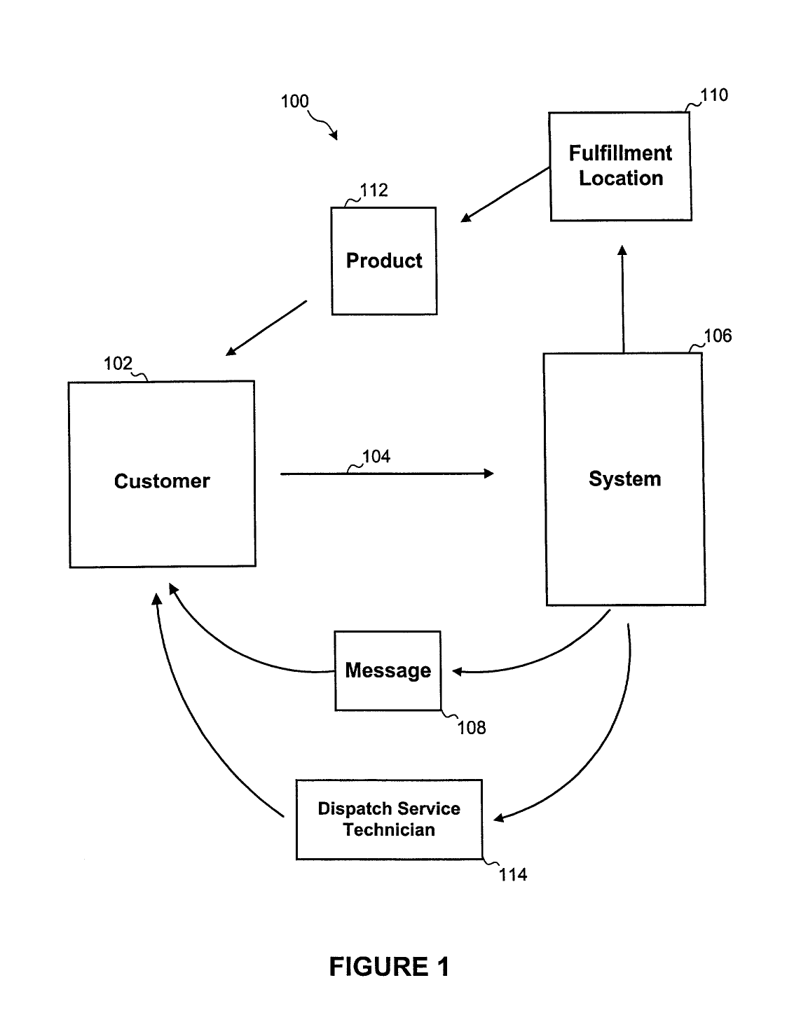

FIG. 1 shows a preferred embodiment of a system 100 in accordance with the present invention. One way of understanding the operation of system 100 is to follow an example of a customer 102 interaction with system 106. The process begins with customer 102 sending information 104 to system 106. This information 104 could be in the form of a completed form that is mailed, faxed or sent to system 106, or an online registration, for example, providing information to a website operated by system 106.

Information 104 includes registration information such as, the name and address of the customer, telephone, facsimile, e-mail of a contact person for the customer and other contact information, filter information, and optionally, dealer or distributor channel information. Additional details related to the kinds of information sent to system 106 is disclosed below.

After system 106 receives information 104, system 106 prepares a response to customer 102. In preparing this response, system 106 uses the information 104 provided by customer 102 to compute or determine an appropriate time for customer 102 to change a filter. This computation can be done in many different ways that will be discussed below.

System 106 can comprise a portion of system resources on a computer, one or more computers, one or more technicians, one or more customer service representatives, or any combination of those resources.

At a time on or before the appropriate filter replacement time, system 106 can respond to customer 102 in the following ways. System 106 can send a message 108 to customer 102 reminding the customer 102 that the appropriate time to replace the filters has or will soon arrive. System 106 can ship the appropriate filter to customer 102. System 106 can also send a message to a fulfillment location 110 and fulfillment location 110 then sends a product 112, in this embodiment the product 112 would be the appropriate filter, to customer 102. System 106 could also dispatch a service technician 114 to customer 102. System 106 can perform one, several or all of these responses. System 106 can ship or remind the customer of one or many filters and system 106 can produce one or many responses.

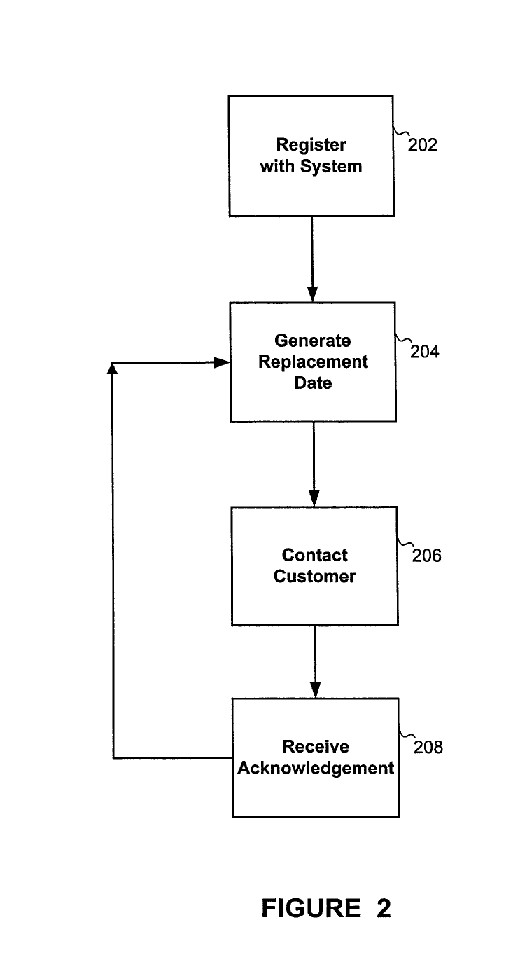

Referring to now FIGS. 1 and 2, wherein FIG. 2 is a schematic flow diagram of a preferred embodiment of the present invention. As shown in FIG. 2, the process begins with step 202 in which a customer 102 (see FIG. 1) registers with system 106 (see FIG. 1). The registration process is disclosed more fully below. Briefly, the registration process provides an opportunity for customer 102 to provide enough information to system 106 so that system 106 can generate a replacement date. This computation of a replacement date occurs in step 204.

After a replacement date for the filter or filters occurs, system 106 contacts customers in step 206. This customer contact can be performed in many different ways and can be performed by combining those different methods. Those different methods of interacting with customer 102 are disclosed in detail below.

In terms of timing, a customer contact can occur on the actual replacement date or before the replacement date to provide enough time to perform other tasks, for example, wait for a reply from customer 102 or allow time for shipping. The customer contact can also occur after the replacement date.

After customer contact has been made, an optional acknowledgement step 208 can be provided. This step is optional and can be omitted. In acknowledgement step 208, customer 102 provides information to system 106 that the products have been successfully delivered. After system 102 receives this acknowledgement, the process returns back to step 204 where a new replacement date is generated.

In some cases, acknowledgement step 208 is omitted and after customer contact has been made, system 102 assumes that customer 102 has performed the necessary filter replacement and the process returns back to step 204 where a new replacement date is calculated.

This process can continue indefinitely or for a predetermined number of cycles. Preferably, the process continues indefinitely until system 106 receives information from customer 102 that customer contact is no longer necessary or desired.

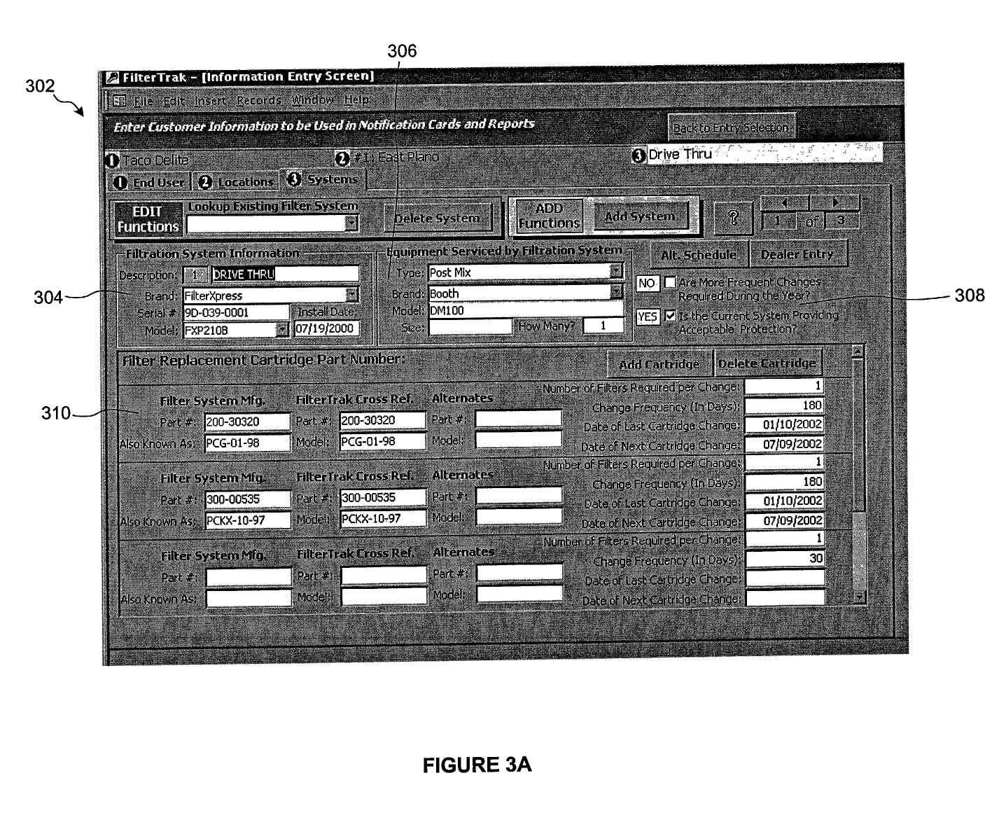

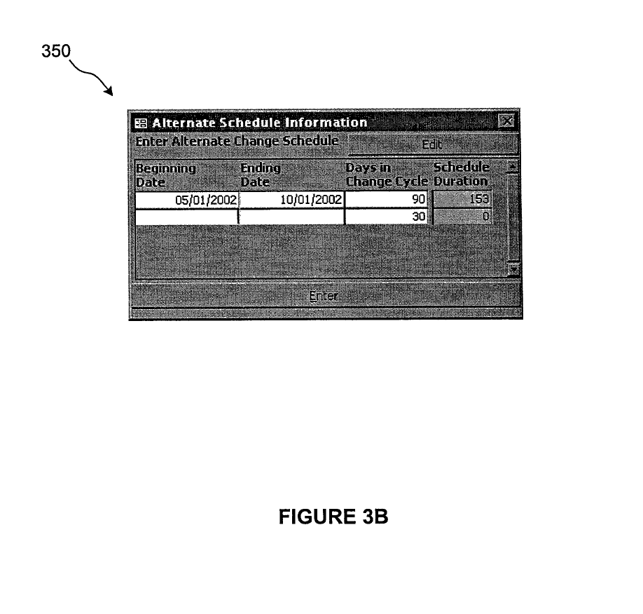

FIG. 3A shows a schematic diagram of a preferred embodiment of a registration interface. Preferably, a graphical user interface (GUI) 302 is used to collect information. GUI 302 includes a filtration system information region 304. In this region, users can enter information related to the type of filtration system they are currently using, such as the brand, the serial number, the model number, and the installation date of the system can be entered. GUI 302 also includes an equipment field where users enter information related to the equipment serviced by the filtration system. Here, users can enter the type of equipment, the brand, the model number, the size, and the quantity of equipment.

GUI 302 also includes a region 308 where users can indicate whether their filter requirements will change throughout the year. If users indicate that their filter requirements will change throughout the year, they can select the “Yes” box. After selecting that box, a dialog box 350, as shown in FIG. 3B, appears. Dialog box 350 permits users to enter one or more different cycles. Users can enter a beginning date, an ending date, the number of days in the cycle, and a duration. The beginning date and ending date define the boundaries of the alternate cycles. The number of days in the cycle define the number days. The information received from dialog box 350 will be discussed in greater detail below.

Returning to FIG. 3A, GUI 302 can also include a portion 310 where users can enter information related to the filter replacement cartridge. Examples of information related to the filter replacement cartridge include: the filter manufacturer's part numbers, the distributor or retailer's cross reference part numbers, and alternate part numbers. In addition, users can enter information indicating the number of filters required per change, the change frequency, the date of the last change, and the date of the next change. Preferably, portion 310 permits users to enter information for more than one filter replacement cartridge.

Other screens can provide opportunities for users to enter their contact information, for example, their name, mailing address, business name, person responsible for changing filters, telephone numbers, usernames, passwords, second addresses, e-mail address, and a notes and comments field. Other screens can permit users to enter information related to their specific location.

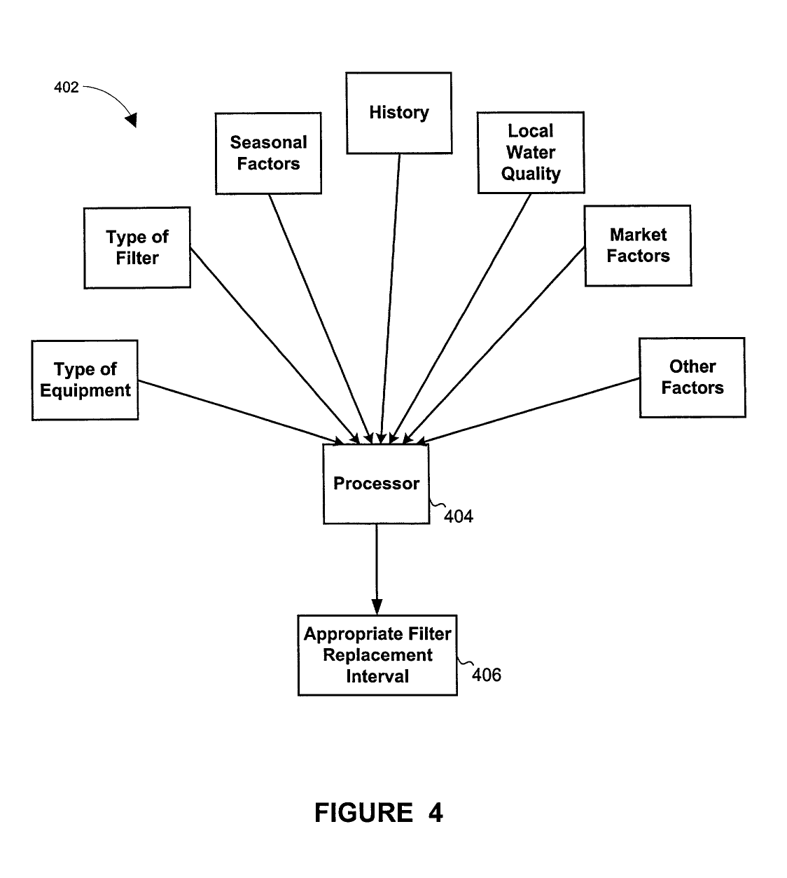

FIG. 4 shows a schematic diagram of a preferred embodiment of a system that is used to determine an appropriate filter replacement date. Different factors 402 are considered by processor 404 to determine an appropriate filter replacement interval. Some factors include the type of equipment, the type of filter, the time of year, the filter replacement history. Other factors could also be considered in determining a filter replacement interval.

In one embodiment, processor 404 uses the information provided by a user, preferably through GUI 302 (see FIGS. 3A and 3B) to determine an appropriate filter replacement interval. For example, if a user entered 180 days for a filter change interval, processor 404 would compute the next date for replacing the filter cartridge to be 180 days from the last date the filter cartridge was changed.

In addition, processor 404 would consider the information received from dialog box 350 to determine if the appropriate replacement interval would be different in certain cases. For example, using the information shown in FIG. 3B, assuming a beginning date of May 1, 2002 and an ending date of Oct. 1, 2002 and assume that the user entered “90” for the number days in cycle. In this case, processor 404 would compute a replacement date 90 days from May 1, 2002. The first replacement date would be Aug. 1, 2002. Since Aug. 1, 2002 is within the beginning and ending dates, processor 404 would compute the second replacement date to be 90 days from Aug. 1, 2002. That second replacement date would be Nov. 1, 2002. Since the second replacement date is outside the beginning and ending dates, processor 404 would return to the typical 180 day cycle.

Preferably, processor 404 perpetually computes replacement dates year after year until processor 404 is instructed to cease computation.

As discussed above, there are many different methods that can be employed to contact the customer 206 (see FIG. 2). The following embodiments of customer contact explain and expand the contact customer step 206 (see FIG. 2) and can be used either singularly or in combination with other customer contact methods.

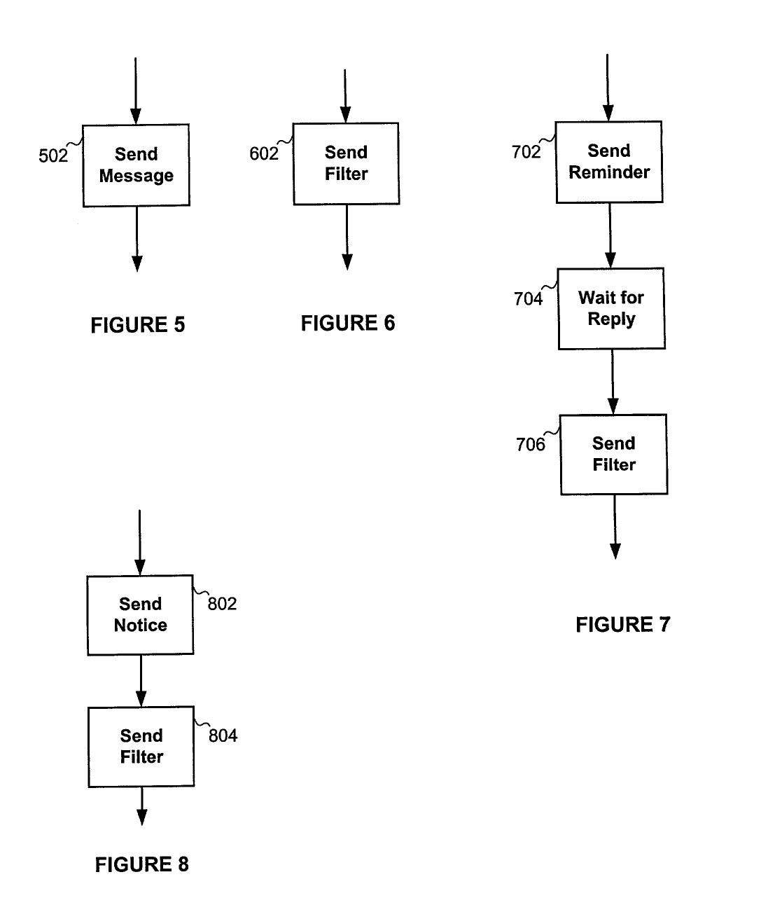

FIG. 5 shows one embodiment of a customer contact. In this embodiment, the customer contact comprises a step 502 of sending a message to a customer. This message could be sent by fax, traditional mail or by electronic mail. Preferably, the preparation and mailing of the letter is automated. One purpose of the letter is to remind the customer to replace at least one filter. The message can contain one or many reminders.

FIG. 6 shows another embodiment of a customer contact. This embodiment includes a step 602 where the replacement filter is simply sent to the customer. In this embodiment, there are no reminders or notices and the customer simply receives the filter at the appropriate time. A message can be sent with the filter informing the customer when to replace the filter because filters are sometimes sent before the actual replacement date. Additionally, a service technician can be dispatched to change the filter.

FIG. 7 shows another customer contact method. This method begins with a step 702 where a reminder message is sent to the customer. The reminder message includes information related to the filter replacement and information on requesting a new filter. In this embodiment, a filter is not sent immediately, but rather, the system waits in the second step 704 for a response from the customer.

In another embodiment, shown in FIG. 8, a message is sent in the first step 802. After the message has been sent, a filter is shipped in the second step 804. In this embodiment, the system does not wait for a response to ship the replacement filter, and, the first message is intended to notify the customer that a filter will be delivered in the near future.

After the contact customer step 206 (see FIG. 2) has been performed, system 106 moves on to the receive acknowledgement step 208, as discussed above. In this way, system 106 is able to notify and/or provide reminders and/or filters to customers at appropriate times.

The application also allows the user to enter the filter system model number and then will automatically load the correct filter cartridge replacement numbers.

The application also allows user to enter the filter system serial number if available and will autoload the channel partner keyed to that serial number as a dealer source for the replacement filters.

The foregoing disclosure of the preferred embodiments of the present invention has been presented for purposes of illustration and description. It is not intended to be exhaustive or to limit the invention to the precise forms disclosed. Many variations and modifications of the embodiments described herein will be obvious to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A system for notifying customers comprising:
means for receiving filter information from a customer;
means for computing a filter replacement date;
means for sending a message to a customer on message date that is related to the filter replacement date.

2. The system according to claim 1, wherein the message date is before the filter replacement date.

3. The system according to claim 1, wherein the message date is the same as the filter replacement date.

4. The system according to claim 1, wherein previous interactions with the customer is stored as historical information.

5. The system according to claim 4, wherein the historical information is considered in computing the filter replacement date.

6. The system according to claim 1, wherein a first filter replacement date and a second filter replacement date define a first filter replacement interval and wherein a third filter replacement date and a fourth replacement date define a second filter replacement interval, and wherein the first replacement interval is different from the second filter replacement interval.

7. The system according to claim 6, wherein the second filter replacement date is the same as the third filter replacement date.

8. A method for notifying customers comprising the steps of:
receiving, from a customer, information related to a filter;
using the information to compute a replacement time for the filter; and
providing a contact with the customer at the replacement time.

9. The method according to claim 8, wherein the contact is information related to the filter and a reminder to replace the filter.

10. The method according to claim 8, wherein the contact is a command to a fulfillment location to ship a replacement filter to the customer.

11. The method according to claim 8, wherein the contact is a message and wherein the system waits for a response after sending the message.

12. The method according to claim 11, wherein while the system is waiting, the system is adapted to receive information from the customer and after receiving the information, sends a product to the customer.

13. The method according to claim 12, wherein the system sends the product to the customer by sending a command to a fulfillment location.

14. The method according to claim 12, wherein the system sends the product by shipping the product.

15. The method according to claim 8, wherein previous interactions with the customer is stored as historical information.

16. The method according to claim 15, wherein the historical information is considered in computing the filter replacement date.

17. The system according to claim 8, wherein a first filter replacement date and a second filter replacement date define a first filter replacement interval and wherein a third filter replacement date and a fourth replacement date define a second filter replacement interval, and wherein the first replacement interval is different from the second filter replacement interval.

18. The system according to claim 8, wherein the system retains information related to customer equipment.

19. The system according to claim 8, wherein the system retains information related to a filter system brand, model number, filter replacement part number, and/or location of filter system.

20. The method according to claim 8, wherein the contact is a service technician dispatch.
